(19) United States
(12) Patent Application Publication
(10) Pub. No.: US 2021/0174617 A1
(43) Pub. Date: Jun. 10, 2021

(54) System for Providing Access to Real Estate Properties

(71) Applicant: Andrew Seth Goldfarb, New York, NY (US)

(72) Inventor: Andrew Seth Goldfarb, New York, NY (US)

(21) Appl. No.: 16/706,766

(22) Filed: Dec. 8, 2019

(51) Int. Cl. G07C 9/00

(52) U.S. Cl. CPC G07C 9/00309; G06Q 50/163; G07C 9/00896

(57) ABSTRACT

The present application relates to a system for providing access to real estate properties. The system may include a property computer accessible via telecommunication network and a user device authenticated to said property computer via a user profile. The property computer may have a database having a plurality of property profiles, and each of the property profiles may be associated with a real property. The user device displays the plurality of property profiles to a user, and each of the property profiles has a corresponding digital key. The property computer is configured to receive a request from the user device for access to the real property and to provide a digital key associated with the real property to the user for the user to access the real property.

### TECHNICAL FIELD

The present disclosure relates generally to a system for providing access to real estate properties, and more particularly to a system for providing access to real estate properties via a digital key that is provided to a user through a smartphone application.

### BACKGROUND

In the real estate industry, prospective buyers or renters (the “prospect”) typically prefer to view a property in person before deciding whether to live there. This typically requires that a real estate professional make themselves available to show the prospect the property in person, in order to give them access and tell them about the features of the property. This process of showing properties in person requires a great deal of communication and coordination in order to schedule viewings at a time that is convenient for all parties. In some cases, real estate professionals also need to coordinate with the property owners in person to obtain a key, and in some cases, multiple real estate professionals need to share a key or coordinate amongst each other to avoid scheduling viewings at the same time.

These logistical tasks are time-consuming and increase the costs associated with real estate transactions. In addition, the hurdles involved in viewing a property make it difficult for the prospect to efficiently view many properties, and so many individuals do not get the home or apartment that is ideal for them. Moreover, the typical process of viewing properties limits the available hours that a prospect can view properties.

Aspects of the present application are directed to overcoming these and other problems.

### SUMMARY

According to an aspect of the present invention, a system for providing access to real estate properties includes: a property computer accessible via telecommunication network; a user device authenticated to said property computer via a user profile; the property computer having a database having a plurality of property profiles, and each of the property profiles is associated with a real property; and the user device displays the plurality of property profiles to a user, and each of the property profiles has a corresponding digital key; wherein the property computer is configured to receive a request from the user device for access to the real property and to provide a digital key associated with the real property to the user.

According to another aspect of the present invention, a method for providing access to real estate properties includes the steps of providing a user device for receiving a plurality of property profiles from a property computer and displaying the plurality of property profiles to a user; selecting via the user device a one of the plurality of property profiles; and transmitting a digital key associated with the selected property profile to the user device.

In addition to, or as an alternative to, one or more of the features described above, further aspects of the present invention can include one or more of the following features, individually or in combination: the digital key provides access to a physical key, and the physical key unlocks a door of the real property; the digital key authenticates the user to a doorman, and the doorman provides the user access to the real property; the digital key is unique to each property profile; the digital key is a digital badge that authenticates the user to a doorman; the digital badge draws user information from the user profile; the user information includes a user photograph; a geofence exists around the real property, and once the user enters the geofence an arrival notification is sent to the property computer; an agent receives a notification that the user has entered the geofence; the agent provides information to the user through the user device upon the agent receiving the notification; unlocking a door of a real property associated with the property profile using the digital key; scanning the digital key with a scanner; authenticating the digital key; unlocking a lockbox containing a physical key to a real property; displaying via the user device a digital badge incorporating the digital key; authenticating via the digital badge the user to a doorman; incorporating user information of the user into the digital badge; connecting an agent to the user such that the agent can provide information relating to a physical property to the user via the user device.

These and other aspects of the present invention will become apparent in light of the drawings and detailed description provided below.

### BRIEF DESCRIPTION OF THE DRAWINGS

FIG. 1 is a schematic of a system for providing access to real estate properties in accordance with the present disclosure.

FIG. 2 is a schematic of a system for providing access to real estate properties as shown in FIG. 1.

FIG. 3 is a schematic of a system for providing access to real estate properties as shown in FIG. 1.

FIG. 4 is a flowchart of a method according to the system of FIG. 1.

FIG. 5 is a flowchart of a method according to the system of FIG. 1.

### DETAILED DESCRIPTION

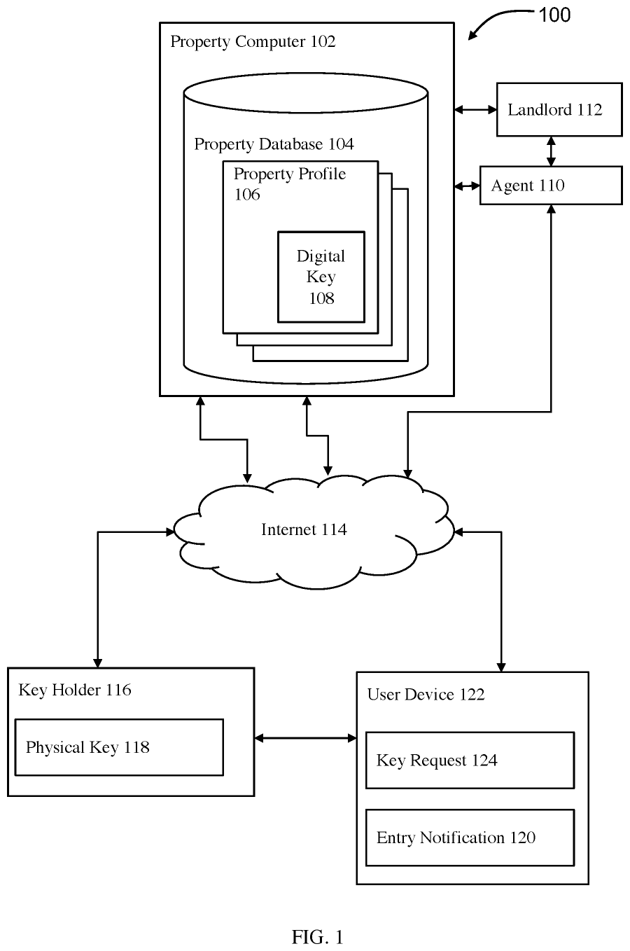

FIG. 1 is a system 100 in accordance with examples described herein. FIG. 1 illustrates a property computer 102, a property database 104, property profiles 106, a digital key 108, an agent 110, a landlord 112, an internet 114, a key holder 116, a physical key 118, an entry notification 120, a user device 122, and a key request 124.

Referring to FIG. 1, the agent 110 provides information to the property computer 102 to generate the property profiles 106 stored on the property database 104, and also views activity in the system 100 provided to the agent 110 by the property computer 102. The landlord 112 provides information to the property computer 102 or the agent 110 for inclusion in the property profiles 106. The property computer 102 and the user device 122 are in communication with each other through the internet 114, and the property computer 102 provides a digital key 108 to the user device 122 upon receiving a key request 124 from the user device 122. The digital key 108 can be used to obtain a physical key 118 from a key holder 116. An entry notification 120 can be generated by the user device 122 and transmitted to the property computer 102.

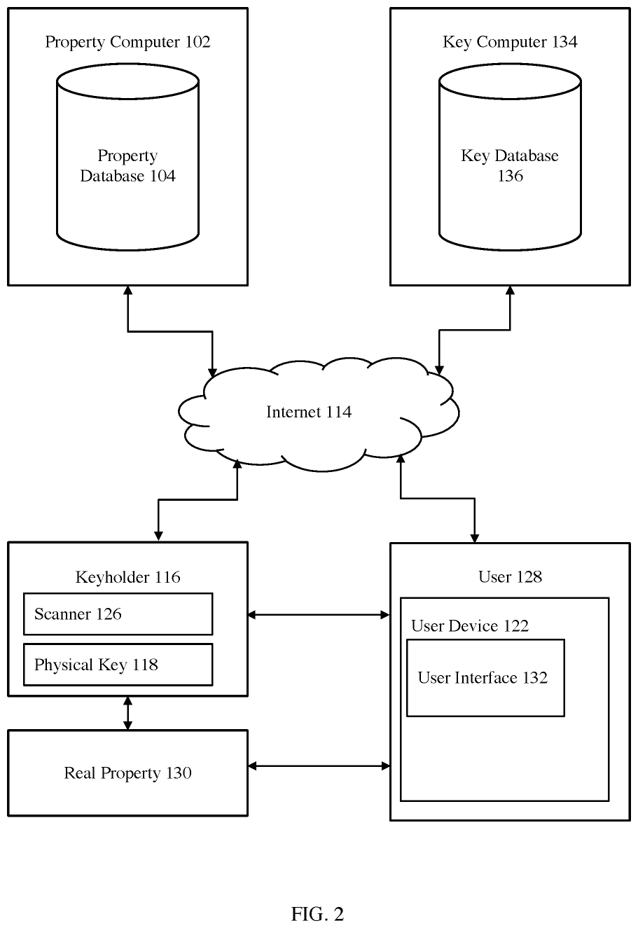

Referring to FIG. 2, the digital key 108 (not shown here for simplicity) may be a code that a user 128 presents to a scanner 126 which allows the user 128 to obtain the physical key 118 from the key holder 116 (e.g. the digital key 108 unlocks a lockbox containing a physical key 118 to the real property 130). The key computer 134 has a key database 136, which stores the digital keys 108 and provides them to the property computer 102, which receives the digital key 108 and associates it with a particular property profile 106 and stores the information in the property database 104. The user 128 browses property profiles 106 on their user device 122, and once the user 128 identifies a property profile 106 that they would like to look at in person, the user requests the digital key 108 for that property profile 106. The property computer 102 then provides the digital key 108 to the user 128 via the user device 122 for display on the user interface 132, which can be presented to the scanner 126. The user 128 then receives the physical key 118 and uses it to unlock a door to the real property 130 so they can view the real property 130 in person. In other embodiments, the scanner 126 may be directly linked to a door of the real property 130, such that the user can use the digital key 108 on the user device 122 to unlock the door directly. In yet other embodiments, the digital key 108 may be a digital badge that is displayed on the user device 122 via the user interface 132. The digital badge might draw information from a user profile associated with the user 128, for example, the digital badge might include a photograph of the user 128. The digital badge might also draw information from the property profile 106. The digital badge would be particularly useful in embodiments of the system 100 where the user 128 is accessing a real property 130 with a doorman, since the user 128 could present the digital badge to the doorman and the doorman could both verify the user 128 and also obtain the information needed to provide the user 128 with access to the correct real property 130.

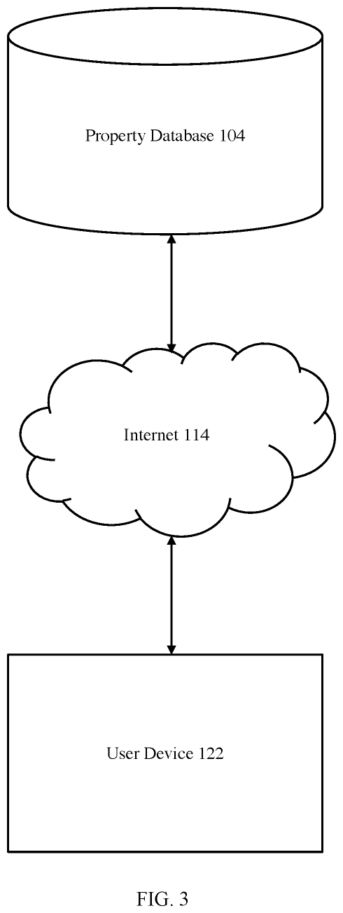

Referring to FIG. 3, a property database 104 is in communication with a user device 122 via the internet 114. In other embodiments, the system shown in FIG. 3 is in communication with one or more systems similar to that shown in FIG. 3. In this way, access to the real property can be shared between different applications. This can be advantageous, for example, if a person using the real estate application of the system shown in FIG. 3, wants to allow a friend access to their real property. Taking advantage of the infrastructure already in place for the real estate application, the information stored in the property database 104 including any digital keys is shared with another database (not shown) and so a secondary application can use that information and thereby provide the functionality necessary to allow the user to provide access to their home to a friend. This process of sharing can allow, for example, tenant apps to take advantage of the infrastructure and information stored on the system for providing access to real estate properties. A person having ordinary skill in the art and the benefit of the present disclosure would understand the synergies that would result in this sharing of infrastructure and database information.

In other embodiments, a business could invite a client to their office and provide the client access to their office using the features described above with respect to FIG. 3. As an example, assume a user buys a ticket to a museum exhibit. The user receives a confirmation email with the calendar invite for the event and also enclosing their ticket. In that same email, a link would be provided which can be used to access the exhibit when the user arrives at the museum. The user would take their phone out when they arrive, and assuming the user is already registered to use the real estate application, they can use that same smart phone application already on their phone to access the museum exhibit. The app would know already know how to generate an access badge or digital key in accordance with the present disclosure, such that the user does not need to have a separate application to access the museum exhibit.

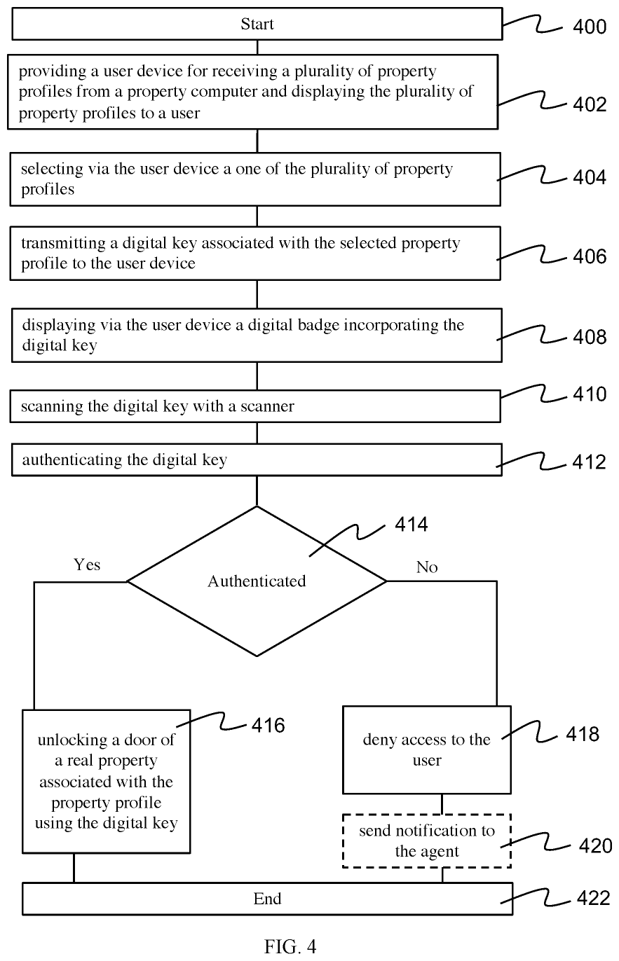

Referring to FIG. 4, a method of providing access to real estate properties in accordance with the system 100 is shown. The method starts 400 and the system provides a user device for receiving a plurality of property profiles from a property computer and displaying the plurality of property profiles to a user 402. A user selects via the user device a one of the plurality of property profiles 404. The property computer transmits a digital key associated with the selected property profile to the user device 406. The user device displays a digital badge incorporating the digital key 408. The user presents the digital key to a scanner that scans the digital key 410. The scanner authenticates the digital key 412. If the digital key is authenticated 414, a door of a real property associated with the property profile may be unlocked 416. If the digital key is not authenticated, then the user will be denied access to the real property 418. Optionally, the method may include the step of sending a notification to the agent 420 in the event that the digital key is not authenticated. The method ends 422. In certain embodiments, the various steps of the method shown in FIG. 4 may be skipped, for example, the system may use either the digital badge or the digital key rather than both.

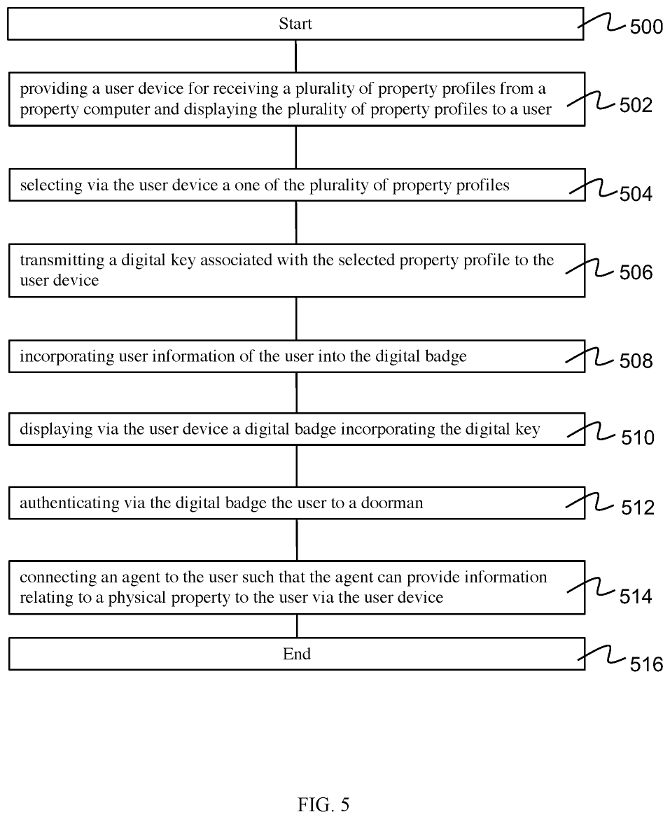

Referring to FIG. 5, a method of providing access to real estate properties in accordance with the system 100 is shown. The method starts 500 and the system provides a user device for receiving a plurality of property profiles from a property computer and displaying the plurality of property profiles to a user 502. A user selects via the user device a one of the plurality of property profiles 504. The property computer transmits a digital key associated with the selected property profile to the user device 506. The user device then incorporates user information of the user into a digital badge 508. The user device displays the digital badge which incorporates the digital key 510. The doorman then looks at the digital badge and authenticates the user 512. Once the user is inside the real property, they are connected to an agent such that the agent can provide information relating to the physical property to the user via the user device 514. The method ends 516. In certain embodiments, the various steps of the method shown in FIG. 5 may be skipped.

In accordance with certain embodiments of the present invention, the digital key 108 may be unique to each property profile 106, each user 128, and/or each key request 124. The digital key 108 may be a code, e.g. a QR code or near-field communication (NFC) code. Acquisition of the digital key 108 may involve the property computer 102 generating a text message, which is sent to the user device 122. The text message includes a link, which the user 128 follows in order to create a user profile. The user profile may be stored on the property computer 102, and may include information like a photograph of the user, the user's name, an account name, account password, property preferences (e.g. neighborhood, square footage, number of beds/baths, proximity to schools/hospitals, walk-up v. elevator, and other preferences known to those of skill in the art having the benefit of the present disclosure), notification or communication preferences, favorite properties, and other user information known to those of skill in the art having the benefit of the present disclosure.

In accordance with certain embodiments of the present invention, the user device 122 presents the user 128 with a user interface 132 that allows the user 128 to input information pertaining to their personal information or the properties. In some embodiments the user 128 inputs their availability so that the property computer 102 can manage the schedules for the various real properties 130 associated with each of the property profiles 106. In other embodiments, the user interface 132 allows the user 128 to input feedback after they visit the real property 130, e.g. a rating out of 5 stars. The property computer 102 may use the feedback to adjust the pricing of the real property 130 or to suggest other property profiles 106 that the user 128 should view. In these embodiments, the property computer 102 will analyze the real properties 130 that the user 128 has visited and the feedback received from them in order to determine the property profiles 106 that are similar. The property computer can optionally incorporate feedback from the agent 110 into the suggestions, and/or the suggestions can be based on the user's current location and the property profiles 106 in that area that are available to be viewed at that time. In certain embodiments, the user 128 can access their own property using the system 100. In these embodiments, the user has a tenant application version of the real estate app running system 100, and this allows them to set up their front door or amenities to be opened using the digital key 108. This can allow a user 128 to not have to rely on separate applications to control access to their own home.

In accordance with certain embodiments of the present invention, the system 100 may include a geo-fence around the real property 130. Once the user device 122 is inside the geo-fence, they are prompted via the user interface 132 to check in. This may generate an entry notification 120 which is transmitted to the property computer 102. In some embodiments, the entry notification 120 may be transmitted directly to the agent 110 or the property computer 102 may generate a subsequent notification that is sent to the agent 110. In general, the use of a geo-fence helps the agent 110 track who has viewed the real property 130 and this information can be used by the agent 110 in a variety of ways apparent to those of ordinary skill in the art having the benefit of the present disclosure.

In accordance with certain embodiments of the present invention, the agent 110 is provided with the opportunity to call the user 128 in order to provide them with information pertaining to the real property 130, or the user 128 may be provided with an option via the user interface 132 to automatically connect with an agent 110 to talk about the real property 130. For example, the agent 110 may be able to provide the user 128 with information about the amenities of the building, the features of the real property 130, the costs of utilities, the neighborhood or schools in the area, and other information apparent to those of ordinary skill in the art having the benefit of the present disclosure. In some embodiments, the user interface 132 may include a video chat to allow an agent 110 to provide the user 128 with a digital tour. The video chat may occur through an ordinary smart phone or it may occur through an augmented reality system, allowing the agent to overlay information and guide the user through a tour of the real property 130. In other embodiments, a digital tour may be pre-recorded and displayed to the user as a video or audio recording. In other embodiments, the user interface 132 provides the user 128 with an integrated chat program to text with the agent 110. The agent 110 may be a virtual agent or a real person. If a virtual agent, the agent may be an artificial intelligence program that integrates with the property computer 102 in order to access the information stored in the property profiles 106 and use that information to provide the user 128 with additional background and features of the real property 130. In other embodiments, users that have already viewed a real property 130 may be offered a promotional rate. In embodiments where the user 128 is presented with a recorded or virtual tour, the tour may include feature tags showing various aspects of the real property 130, and it may also include virtual furnishings to help the user 128 appreciate the potential of the real property 130.

In accordance with certain embodiments of the present invention, the property computer 102 has an agent portal where agents 110 are able to collect data accumulated by the activity in the system 100. For example, the property computer may display the numbers of visits with the property profiles 106, applications for that property profile 106, and other data collected during individual visits to the real property 130. The agent portal also can provide the agent 110 with tools to use while giving a virtual tour to the user 128. The agent portal provides the agent 110 with a variety of business opportunities to help facilitate their work and operate more efficiently.

In accordance with certain embodiments of the present invention, the system 100 may include features specifically designed to protect the privacy of a user 128. The system 100 does not include an integrated video camera that watches a user 128 as they view the property. This aspect of the system 100 is intended to protect the privacy of the user 128 and in turn encourage use of the system 100.

In accordance with certain embodiments of the present invention, the agent 110 might be a real estate professional. In other embodiments, the agent 110 might also be a current tenant of the real property 130. The system 100 may thus provide a great deal of value prospect in lease break situations. For example, current tenants would have the ability to put their apartment up for lease ahead of the expiration date on their lease. This cuts down on vacancy loss for the landlord and can also help a tenant find a replacement tenant in order to allow them to leave a lease early. This could also help a tenant find a roommate, or replacement for a departing roommate. Similarly, if the system 100 is implemented with a current tenant as the agent 110, the agent 110 can use the system 100 to provide access to the real property to visiting family and friends, contractors, dog walkers, or any other person that requires access to the real property 130. In these applications, the system 100 may act as a sign-in sheet such that the entry notification 120 is provided to the tenant, the landlord, and/or the doorman.

In accordance with certain embodiments of the present invention, the system 100 can be gamified in order to increase usage and engagement with the system 100 by users 128 (e.g. potential tenants). In these embodiments, the system 100 will provide points to the user 128 for certain activities, and the points can be redeemed for various rewards. For example, the user 128 may receive points for viewing a property profile 106, favoriting the property profile 106, visiting a real property 130, speaking to an agent 110, and other activities described herein and known to those of skill in the art having the benefit of the present disclosure. The rewards may include providing the user 128 with hidden deals and discounts. The system 100 may also categorize users 128 based on how many points they have obtained with pre-set point levels defining one or more categories. A user 128 may be treated differently by the system 100 based on their achieved category, including access to various types of deals, discounts, special offers, and other preferential treatment by a doorman or an agent 110. For example, a user 128 may be provided with a hidden deal where they are provided with a property profile 106 and presented with a timer through the user interface 132. The user 128 has to either visit the real property 130 associated with the property profile 106 or put in an application for the real property 130 before the timer runs out in order to receive the special offer.

Example advantages of systems described herein may include increases in speed and efficiency for prospects accessing real properties, streamlined access and sales of real property, enabling sharing and connecting between prospects and agents. Note that the advantages described herein are provided to facilitate an appreciation of examples of the described technology. It is to be understood that examples of the described technology may not exhibit all, or even any, of the described advantages.

From the foregoing it will be appreciated that, although specific embodiments have been described herein for purposes of illustration, various modifications may be made while remaining within the scope of the claimed technology.

Examples described herein may refer to various components as “coupled” or signals as being “sent/transmitted to” or “received/retrieved from” certain components. It is to be understood that in some examples the components are directly coupled one to another, while in other examples the components are coupled with intervening components or networks disposed between them. Similarly, a signal may be provided directly to and/or received directly from the recited components without intervening components, but also may be provided to and/or received from the certain components through intervening components.

While several embodiments have been disclosed, it will be apparent to those of ordinary skill in the art having the benefit of the present disclosure that aspects of the present disclosure include many more embodiments and implementations. Accordingly, aspects of the present disclosure are not to be restricted except in light of the attached claims and their equivalents. It will also be apparent to those of ordinary skill in the art having the benefit of the present disclosure that variations and modifications can be made without departing from the true scope of the present disclosure. For example, in some instances, one or more features disclosed in connection with one embodiment can be used alone or in combination with one or more features of one or more other embodiments.

1. A system for providing access to real estate properties, comprising:
a property computer accessible via telecommunication network;
a user device authenticated to said property computer via a user profile;
the property computer having a database having a plurality of property profiles, and each of the property profiles is associated with a real property; and
the user device displays the plurality of property profiles to a user, and each of the property profiles has a corresponding digital key;
wherein the property computer is configured to receive a request from the user device for access to the real property and to provide a digital key associated with the real property to the user
wherein a geofence exists around the real property, and once the user enters the geofence an arrival notification is sent to the property computer;
wherein an agent receives a notification that the user has entered the geofence; and
wherein the agent provides information relating to features of the real property to the user through the user device upon the agent receiving the notification.

2. The system of claim 1, wherein the digital key provides access to a physical key, and the physical key unlocks a door of the real property.

3. The system of claim 1, wherein the digital key authenticates the user to a doorman, and the doorman provides the user access to the real property.

4. The system of claim 1, wherein the digital key is unique to each property profile.

5. The system of claim 1, wherein the digital key is a digital badge that authenticates the user to a doorman.

6. The system of claim 5, wherein the digital badge draws user information from the user profile.

7. The system of claim 6, wherein the user information includes a user photograph.

8. (canceled)

9. (canceled)

10. (canceled)

11. A method for providing access to real estate properties comprising the steps of:
providing a user device for receiving a plurality of property profiles from a property computer and displaying the plurality of property profiles to a user, where each of the property profiles is associated with a real property;
selecting via the user device a one of the plurality of property profiles;
transmitting a digital key associated with the selected property profile to the user device;
providing a geofence around the real property and once the user enters the geofence, sending an arrival notification to the property computer;
receiving by an agent a notification that the user has entered the geofence; and
providing information relating to the real property by an agent to the user through the user device upon the agent receiving the notification.

12. The method of claim 11, further comprising the step of:
unlocking a door of a real property associated with the property profile using the digital key.

13. The method of claim 11, further comprising the steps of:
scanning the digital key with a scanner;
authenticating the digital key;
unlocking a lockbox containing a physical key to a real property.

14. The method of claim 11, further comprising the steps of:
displaying via the user device a digital badge incorporating the digital key;
authenticating via the digital badge the user to a doorman.

15. The method of claim 14, further comprising the steps of:
incorporating user information of the user into the digital badge.

16. The method of claim 11, further comprising the steps of:
connecting an agent to the user such that the agent can provide information relating to a physical property to the user via the user device.

17. The system of claim 1, wherein the agent provides the information to the user through a video chat consisting of a digital tour of the real property.

18. The system of claim 17, wherein the video chat is conducted through an augmented reality system, allowing the agent to overlay the information and guide the user through the digital tour of the real property.

19. The system of claim 18, wherein the digital tour includes virtual furnishings to help the user appreciate the potential of the real property.

20. The system of claim 18, wherein the digital tour includes feature tags showing various aspects of the real property.

21. The system of claim 1, wherein the user is provided with a hidden deal through a user interface on the user device, the hidden deal is connected to a timer that is also presented to the user through the user interface, and the user must qualify for the hidden deal by applying for the real property before the timer expires in order to receive the special offer provided by the hidden deal.
